(19) United States
(12) Patent Application Publication
(10) Pub. No.: US 2011/0006950 A1
(43) Pub. Date: Jan. 13, 2011

(54) MICROSTRIP ANTENNA COMPRISED OF TWO SLOTS

(75) Inventors: Ikmo Park, Gyeonggi-do (KR); Byoungchul Kim, Gyeonggi-do (KR); Sung Min Han, Daejeon (KR); Joon Gyu Ryu, Daejeon (KR); Dae Ig Chang, Daejeon (KR); Ho Jin Lee, Daejeon (KR)

Correspondence Address: RABIN & Berdo, PC, 1101 14TH STREET, NW, SUITE 500, WASHINGTON, DC, 20005, US

(73) Assignees: Electronics and Telecommunications Research Instit, Daejeon (KR); Ajou University Industry-Academic Cooperation Foun, Gyeonggi-do (KR)

(21) Appl. No.: 12/920,047

(22) PCT Filed: Nov. 26, 2008
(86) PCT No.: PCT/KR2008/006969

§ 371 Date: Aug. 27, 2010

(30) Foreign Application Priority Data
Feb. 28, 2008 (KR) 10-2008-0018577

(51) Int. Cl. H01Q 9/04; H01Q 1/38

(52) U.S. Cl. 343/700 MS

(57) ABSTRACT

Disclosed relates to a microstrip antenna, particularly, relates to a dual band microstrip antenna including two slots. The microstrip antenna includes a conductor plate having a first hole and a substrate having a microstrip patch where slots of two different sizes are positioned, the substrate being located on a top of the conductor plate.

### TECHNICAL FIELD

The present invention relates to a microstrip antenna, particularly, to a multiple-band microstrip antenna having two slots.

This work was supported by the IT R&D program of MIC/IITA [2006-S-020-02, Development of Internet satellite wireless interlock of a high speed object].

### BACKGROUND ART

A Wireless Local Area Network (WLAN) is a technology that enables the use of high speed Internet through a PDA, notebook, and computer within a certain distance around a location where a wireless access point is set. That is, the WLAN being free from a wired LAN can provide every advantage and function that the conventional wired LAN provides. WLAN service based on 802.11b of a 2.4 GHz band has been assessed as having disadvantages in transmission rate, security, and interworking with a potable Internet service. Conversely, a 5 GHz band based on IEEE 802,11a standard with high transmission rate recently attracts public attention. Therefore, requirement to include the both bands appears.

However, there is no significant problem to provide the service when the service is provided in a downtown location where an existing terrestrial network is well established, but there is a limitation when the service is provided in an area with restrictive access such as mountains, islands or other remote place, high speed train, airplane, marine ship, and the like. Accordingly, a study is under way to provide effective service to broader area using a satellite. However, even when providing the service with the satellite, there is a problem in that the service is discontinued when a high speed object passes through a shadow area where a satellite signal cannot directly reach, such as a tunnel. Since the tunnel is a typical shadow area, for reliable service in the tunnel, development of an antenna for a signal relay apparatus with optimum performance in a wireless environment of when the high speed object passes through the tunnel is absolutely required.

A dual band microstrip antenna used as a relay station for providing satellite Internet service is required to accept a band of 802.11a and 802.11b, which is a band between 2.4 GHz and 2.483 GHz and a band between 5.725 GHz and 5.825 GHz, and also is required to have a vertical polarization and a radiation pattern in a similar shape as an operating range.

In general, since a microstrip antenna has a feature of a narrow band, many methods for improving a bandwidth are suggested. Also, a method using a thick dielectric substance, a method using a laminated structure, and a method using a parasitic element are suggested. However, those methods have a problem in that the overall size of an antenna becomes larger.

An antenna with a microstrip patch where U-type of a slot is positioned has a relatively wider bandwidth than conventional microstrip antenna. This is a method that can induce an additional resonance frequency by the U-type of slot close to a resonance frequency by a patch, wherein an antenna for broadband can be designed with only a single element. However, when a relatively higher resonance frequency is equal to or greater than two times a relatively lower resonance frequency, the radiation pattern may be altered. Thus, an antenna that can accept the dual band and also can satisfy the size and same radiation pattern is required.

### DISCLOSURE OF INVENTION

### Technical Problem

An aspect of the present invention provides a microstrip antenna which has two slots, and thereby enabling a vertical polarization and a radiation pattern in a similar shape in a dual band.

### Technical Solution

According to an aspect of the present invention, there is provided a microstrip antenna, including: a conductor plate having a first hole and a substrate having a microstrip patch where slots of two different sizes are positioned, the substrate being located on a top of the conductor plate.

### BRIEF DESCRIPTION OF THE DRAWINGS

FIG. 1 is a perspective view illustrating a microstrip antenna including two slots according to an example of the present invention;

FIG. 2 is a exploded perspective view of FIG. 1;

FIG. 3 illustrates a feature of a return loss according to a frequency of a microstrip antenna including two slots according to an example embodiment of the present invention;

FIGS. 4 and 5 illustrate a feature of 2.44 GHz radiation of a microstrip antenna including two slots according to an example embodiment of the present invention; and

FIGS. 6 and 7 illustrate a feature of 5.69 GHz radiation of a microstrip antenna including two slots according to an example embodiment of the present invention.

### MODE FOR THE INVENTION

Although a few exemplary embodiments of the present invention have been shown and described, the present invention is not limited to the described exemplary embodiments, wherein like reference numerals refer to the like elements throughout.

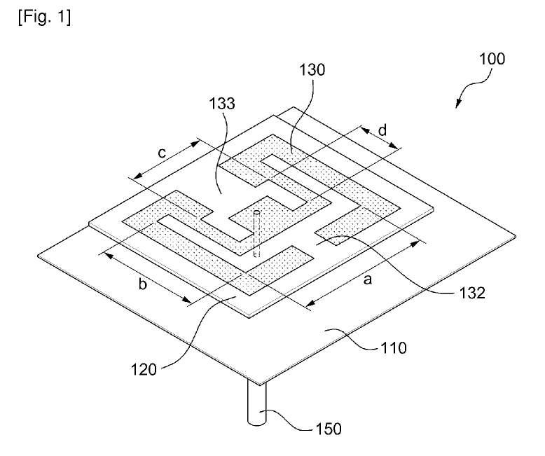

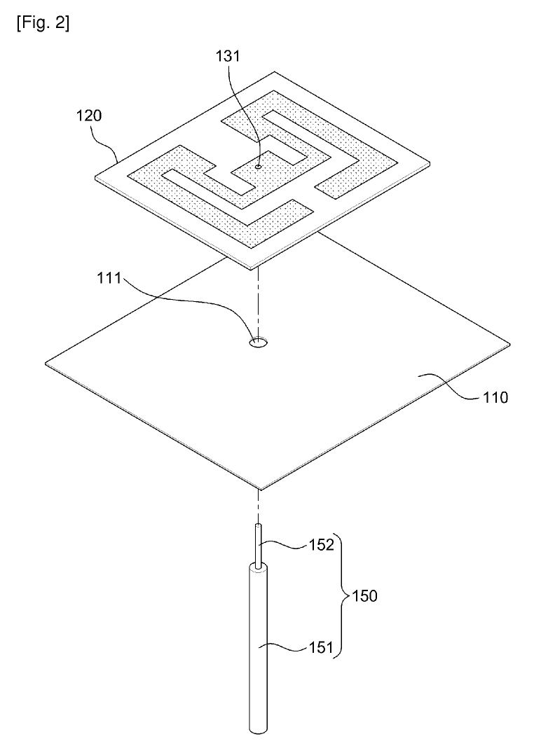

FIG. 1 is a perspective view illustrating a microstrip antenna including two slots and FIG. 2 is a divided perspective view of FIG. 1.

Referring to FIGS. 1 and 2, the microstrip antenna 100 includes a conductor plate 110, substrate 120, and coaxial line 150.

The conductor plate 110 includes a first hole 111 and serves as a ground connection.

The substrate 120 is located on a top of the conductor plate 110 and has a relative dielectric constant (εᵣ) of 3.38 and a thickness of 0.508 mm. A certain interval between the conductor plate 110 and substrate 120 exists, thereby having a layer of air. The substrate 120 includes a microstrip patch 130 and a plurality of slots positioned in the microstrip patch 130.

The microstrip patch 130 may include a second hole 131 and a size of the microstrip patch 130 may be 50×47 mm.

The plurality of slots may be two Y-type slots, a first Y-type slot and a second Y-type slot 132 and 133. The first Y-type slot 132 faces opposite to the second Y-type slot 133. A length, width, and location of the first and second Y-type slots 132 and 133 may be changed according to a resonance frequency that the slots induce. In this instance, the resonance frequency intended to be induced may be altered without affecting each other by respectively changing slots.

Here, the first Y-type slot 132 induces a relatively lower frequency and the second Y-type slot 133 induces a relatively higher frequency. Accordingly, the first Y-type slot 132 is bigger than the second Y-type slot 133. For example, a width (a) and height (b) of the first Y-type slot is respectively 46 mm and 38 mm and its width may be 3.5 mm. Also, a width (c) and height (d) of the second Y-type slot 133 is respectively 23.5 mm and 14 mm and its width may be 5.5 mm.

The coaxial line 150 includes an external conductor 151 and internal conductor 152. The coaxial line 150 may pass through the first hole 111 of the conductor plate 110 and the second hole 131 of the substrate 120, and is located to be in contact with a microstrip patch 130, thereby performing feeding. Specifically, a lower part of the coaxial line 150 includes an external conductor 151 and internal conductor 152 and an upper part of the coaxial line is comprised of an internal conductor 152. That is, the external conductor 151 and internal conductor 152 of the coaxial line 150 are built up to the conductor plate 110 and the internal conductor 152 of the coaxial line 150 is exposed between the conductor plate 110 and microstrip patch 130. In this instance, a diameter of the internal conductor 152 is 1.6 mm, and a height of the exposed internal conductor 152 is 6.5 mm. The internal conductor 152 may be located in 24.5 mm from a top of the microstrip patch 130. Therefore, a first hole 111 of the conductor plate 110 corresponds to a size of the external conductor 151 of the coaxial line 150, namely, a circumference of the external conductor 151, and a second hole 131 of the microstrip patch 130 corresponds to a size of the internal conductor 152 of the coaxial line 150, namely, a circumference of the internal conductor 152.

A radiation to a space occurs by an induced electrical current at a patch when a signal is provided through the coaxial line, and thus the microstrip antenna can perform as an antenna.

The above described microstrip antenna includes the first and second Y-type slot, and thereby can perform in dual bands. Also, the microstrip antenna can independently adjust the resonance frequency band by changing each Y-type slot.

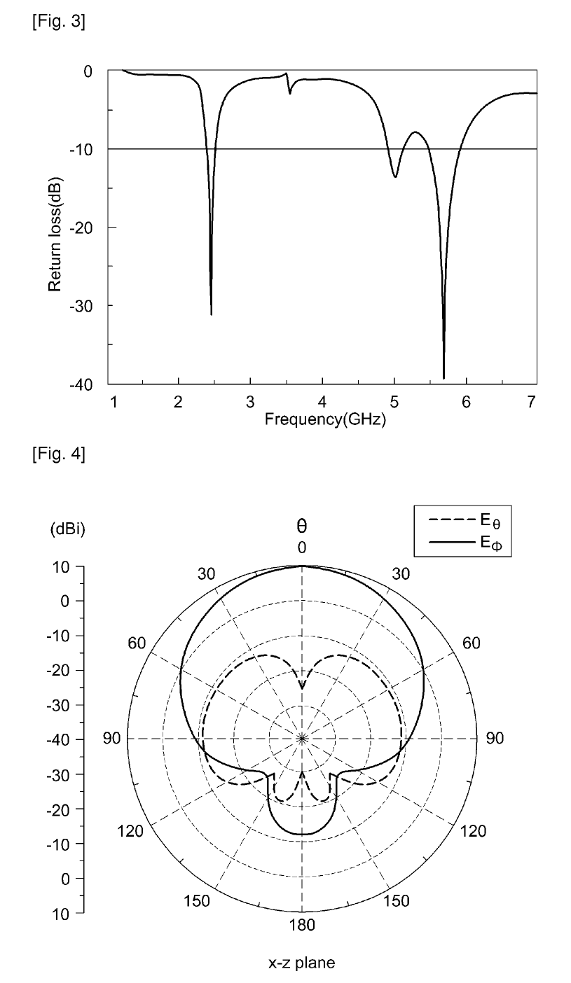

FIG. 3 illustrates a feature of a return loss according to a frequency of a microstrip antenna including two slots according to an example embodiment of the present invention.

Referring to FIG. 3, the return loss of the microstrip antenna in a band 2.389 to 2.504 GHz and 5.489 to 5.928 GHz is respectively about 32 dB and 40 dB, which are outstandingly higher than a return loss in other frequency band. Therefore, a Voltage Standing Wave Ratio (VSWR) of the microstrip antenna is less than 2. This means that the microstrip antenna can perform in a dual band, 2.389 to 2.504 GHz and 5.489 to 5.928 GHz.

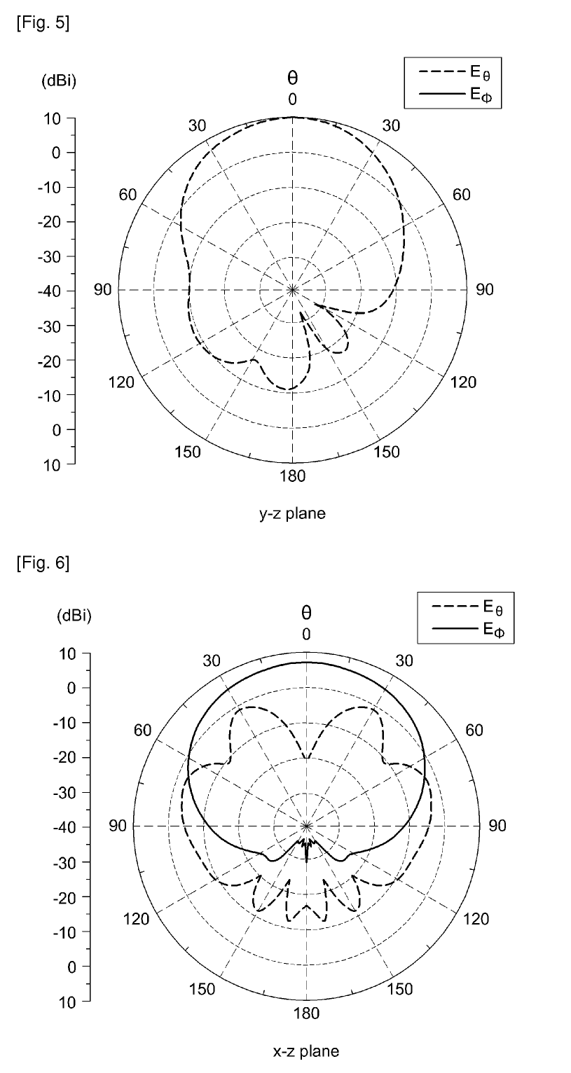

FIGS. 4 and 5 illustrate a feature of 2.44 GHz radiation of a microstrip antenna including two slots according to an example embodiment of the present invention.

Referring to FIGS. 4 and 5, a radiation pattern of an x-z plane and y-z plane in a relatively lower central frequency where the antenna performs, 2.43 GHz, is recognized and a gain of 9.77 dBi is obtained.

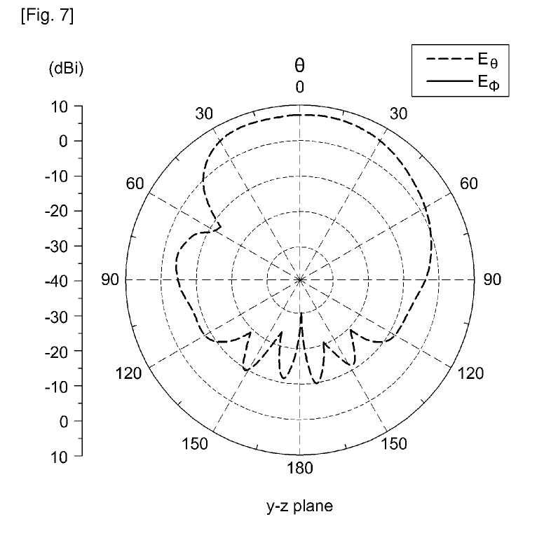

FIGS. 6 and 7 illustrate a feature of 5.69 GHz radiation of a microstrip antenna including two slots according to an example embodiment of the present invention.

Referring to FIGS. 6 and 7, a radiation pattern of an x-z plane and y-z plane in a relatively higher central frequency where the antenna performs, 5.69 GHz, is recognized and a gain of 7.76 dBi is obtained.

As described above, the microstrip antenna according to the present invention position two slots of different sizes into a patch, and thereby can accept both 802.11a and 802.11 b bands and obtain a gain equal to or greater than 7 dBi, and have a radiation pattern in a similar shape. Therefore, the microstrip antenna according to the present invention may be applicable to an antenna for WLAN and antenna for a signal relay apparatus to provide a satellite Internet service, and further applicable to a base station, satellite mobile communication technique, and communication technique for military use.

An micro strip antenna according to the present invention may be recorded computer-readable media including program instructions to implement various operations embodied by a computer. The media may also include, alone or in combination with the program instructions, data files, data structures, and the like. The program instructions may be those specially designed and constructed for the purposes of example embodiments, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A microstrip antenna, comprising:
a conductor plate having a first hole; and
a substrate having a microstrip patch where slots of two different sizes are positioned, the substrate being located on a top of the conductor plate.

2. The microstrip antenna of claim 1, wherein a length, width, and location of the two slots are changed according to a resonance frequency that the slots induce.

3. The microstrip antenna of claim 1, wherein the two slots include a first Y-type slot and a second Y-type slot, and the first Y-type slot faces opposite to the second Y-type slot.

4. The microstrip antenna of claim 3, wherein the first Y-type slot is bigger than the second Y-type slot.

5. The microstrip antenna of claim 3, wherein the first Y-type slot induces a relatively lower resonance frequency and the second Y-type slot induces a relatively higher resonance frequency.

6. The microstrip antenna of claim 1, wherein the substrate has a second hole, and further comprises:
a coaxial line that passes through the first and second holes and contacts with the microstrip patch.

7. The microstrip antenna of claim 6, wherein a size of the first hole corresponds to a circumference of an external conductor of the coaxial line.

8. The microstrip antenna of claim 6, wherein a size of the second hole corresponds to a circumference of an internal conductor of the coaxial line.

9. The microstrip antenna of claim 1, wherein a relative dielectric constant of the substrate is from 3 to 4 and a thickness of the substrate is from 0.5 mm to 0.6 mm.
